(19) United States
(12) Patent Application Publication
(10) Pub. No.: US 2014/0118733 A1
(43) Pub. Date: May 1, 2014

(54) Multiple-Vial, Rotating Sample Container Assembly for Raman Spectroscopy

(71) Applicant: Brisco Harward, Morrisville, NC (US)

(72) Inventor: Brisco Harward, Morrisville, NC (US)

(73) Assignee: MUSTARD TREE INSTRUMENTS, LLC, Research Triangle Park, NC (US)

(21) Appl. No.: 14/066,035

(22) Filed: Oct. 29, 2013

Related U.S. Application Data
(60) Provisional application No. 61/720,329, filed on Oct. 30, 2012.

(51) Int. Cl. G01N 21/65; G01N 1/00

(52) U.S. Cl. CPC G01N 21/65; G01N 1/00
USPC 356/301

(57) ABSTRACT

A multiple-vial, rotating, sample container assembly for Raman spectroscopy comprises a container with two or more receptacles formed therein, which are suitable for positioning two or more vials inside the sample measurement area of a spectrometer. The openings are located such that when the container is rotated, the vials inside the holder are alternately positioned in the laser beam path, and the Raman scattering from each sample material is co-collected during the same measurement period. The rotation of the container (RPM) is sufficiently fast so that the material in each vial is measured many times during a sampling period, thereby ensuring a high degree of reproducibility in measuring the combination of vials. For a quantitative or peak comparison method, one vial contains a reference material. This material may be pure (100% of a compound), a dilution of the material in a solvent (such as water), or a combination of materials. Another vial contains the sample, or material to be evaluated.

This application claims priority to U.S. Provisional Patent Application Ser. No. 61/720329, titled, “Multiple-Vial, Rotating Sample Container Assembly for Raman Spectroscopy,” filed Oct. 30, 2012, the disclosure of which is incorporated herein by reference in its entirety.

### FIELD OF INVENTION

The present invention relates generally to Raman spectroscopy, and in particular to a multiple-vial, rotating, sample container assembly allowing for the co-collection of Raman spectra from two or more materials.

### BACKGROUND

Raman spectroscopy is an analytic instrumentation methodology useful in ascertaining and verifying the molecular structures of materials. Raman spectroscopy relies on inelastic scattering, or Raman scattering, of monochromatic light, resulting in an energy shift in a portion of the photons scattered by a sample. From the shifted energy of the Raman scattered photons, vibrational modes characteristic to a specific molecular structure can be ascertained. In addition, by analytically assessing the relative intensity of Raman scattered photons, the concentration of a sample can be quantitatively determined.

Typically, a sample is illuminated with a laser beam. Light from the illuminated spot is collected by lenses and analyzed. Wavelengths close to the laser line due to elastic Rayleigh scattering are blocked or filtered out, while chosen bands of the collected light are directed onto a detector.

The Raman effect occurs when light impinges upon a molecule and interacts with the electron cloud and the bonds of that molecule. For the spontaneous Raman effect, which is a form of light scattering, a photon excites the molecule from its ground state to a virtual energy state. The energy state is referred to as virtual since it is temporary, and not a discrete (real) energy state. When the molecule relaxes, it emits a photon and it returns to a different rotational or vibrational state. The difference in energy between the original state and this new state leads to a shift in the emitted photon's frequency away from the excitation wavelength.

If the final vibrational state of the molecule is more energetic than the initial state, then the emitted photon will be shifted to a lower frequency in order for the total energy of the system to remain balanced. This shift in frequency is known as a Stokes shift. If the final vibrational state is less energetic than the initial state, then the emitted photon will be shifted to a higher frequency, which is known as an Anti-Stokes shift. Raman scattering is an example of inelastic scattering because of the energy transfer between the photons and the molecules during their interaction.

The pattern of shifted frequencies is determined by the rotational and vibrational states of the sample, which are characteristic of the molecules. The chemical makeup of a sample may thus be determined by an analysis of the Raman scattering.

For quantitative Raman analysis, normalization of the scattered spectra using a constant or standard peak is recommended. See U.S. Pharmacopeial Convention (USP) Monograph 1120, “Raman Spectroscopy Theory and Practice,” the disclosure of which is incorporated herein by reference in its entirety. Several approaches to providing such normalization are known.

One approach is to mix an excipient or solvent with the sample. The excipient or solvent is ideally selected to exhibit a Raman spectroscopic peak which essentially remains unchanged (i.e., constant intensity) as the analyte concentration in the sample varies. However, mixing materials with the sample in one container presents numerous problems. Raman spectroscopy results may vary due to inaccuracies in dispensing and mixing of the different materials. Additionally, potential undesired chemical reactions between the materials may occur, altering the sample's composition and/or concentration.

Another approach to providing a reference Raman spectroscopic peak is to pass the excitation laser beam through a reference window comprising or impregnated with the reference material. Raman scattered photons are collected from both the sample and the reference window. However, this approach also has known deficiencies. Raman scattered photons typically comprise less than one part per million of the optical return from an excitation laser beam, and consequently already exhibit a low Signal to Noise Ratio (SNR). Passing Raman scattered photons from the analyte through a filter attenuates the optical signal, reducing the SNR even further. This requires a more sensitive detector, and/or more sophisticated signal processing, to achieve a sufficiently strong signal.

The background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, a multiple-vial, rotating, sample container assembly for Raman spectroscopy comprises a container with two or more receptacles formed therein, which are suitable for positioning two or more vials inside the sample measurement area of a spectrometer. The openings are located such that when the container is rotated, the vials inside the holder are alternately positioned in the laser beam path, and the Raman scattering from each sample material is co-collected during the same measurement period. The rotation of the container (RPM) is sufficiently fast so that the material in each vial is measured many times during a sampling period, thereby ensuring a high degree of reproducibility in measuring the combination of vials. For a quantitative or peak comparison method, one vial contains a reference material. This material may be pure (100% of a compound), a dilution of the material in a solvent (such as water), or a combination of materials. Another vial contains the sample, or material to be evaluated.

In one embodiment, by using a series of samples with known concentrations of the material of interest, a calibration curve may be constructed using the ratio of Raman peaks. Using this calibration relationship, an unknown sample may be tested and the concentration determined by measuring the sample using the same device and reference standard. Either Raman peak heights or peak areas may be used in this determination.

One embodiment relates to a Raman spectroscopy system. The system includes an excitation laser source operative to selectively generate an excitation laser beam in a fixed position; an optical system operative to collect Raman scattered photons from material excited by the laser beam; a detector positioned and operative to detect Raman scattered photons collected from the material; a data processor operative to analyze the spectra of Raman scattered photons detected by the detector; and a rotating container having at least two receptacles formed therein, each receptacle operative to hold a vial containing material to be analyzed by the Raman spectroscopy system, the receptacles arranged to alternately pass each vial over the excitation laser beam as the container rotates.

Another embodiment relates to a method of performing Raman spectroscopy on two or more different materials simultaneously. An excitation laser source operative to selectively generate an excitation laser beam in a fixed position is provided. At least two materials, each in a vial disposed in a rotating container, are also provided. The container is rotated such that each vial is alternately illuminated by the excitation laser beam as the container rotates. Raman spectroscopy is performed on an optical signal generated by the excitation laser alternately illuminating each material as the container rotates.

Yet another embodiment relates to a non-transient computer readable media storing program instructions operative to control a Raman spectroscopy system. The system includes an excitation laser source operative to selectively generate an excitation laser beam in a fixed position, and at least two materials, each in a vial disposed in a rotating container. The program instructions are operative to cause a controller to control mechanical means to rotate the container such that each vial is alternately illuminated by the excitation laser beam as the container rotates; and perform Raman spectroscopic analysis on an optical signal generated by the excitation laser alternately illuminating each material as the container rotates.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a perspective view of a multiple-vial, rotating, sample container assembly.

FIG. 2 is a perspective view of a multiple-vial, rotating, sample container assembly depicting the containers both in and out of the assembly.

FIG. 3 is a perspective view of the bottom of the multiple-vial, rotating, sample container, with a laser path illustrated.

FIG. 4 is a section view of the multiple-vial, rotating, sample container assembly and Raman spectrometer and optical system.

FIG. 5 is a representative Raman spectrograph of two different concentrations of sample material and a common reference material.

FIG. 6 is graph of a calibration curve obtained using the multiple-vial, rotating, sample container assembly.

### DETAILED DESCRIPTION

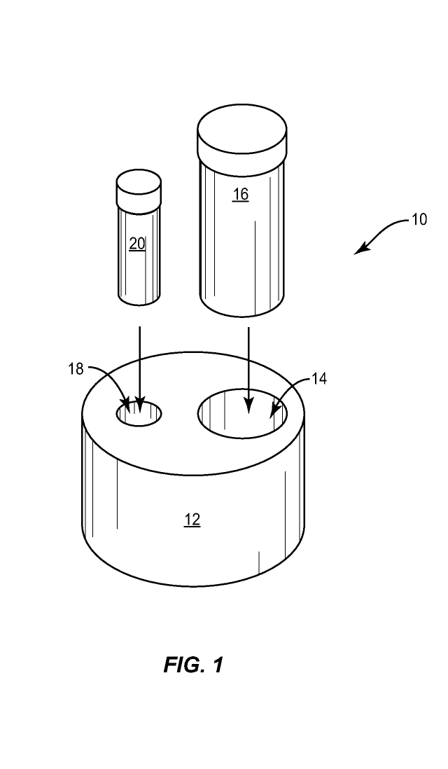

FIG. 1 depicts a multiple-vial, rotating, sample container assembly 10 for performing Raman spectroscopy of a desired sample and a reference material simultaneously. The assembly 10 comprises a multiple-vial, rotating, sample container 12. The container 12 is preferably formed from a material with low Raman activity, such as black Delrin®. A first cylindrical hole is formed in the container 12, forming a receptacle 14 for a corresponding first vial 16. Also formed in the container 12 is a second cylindrical hole, forming a receptacle 18 for a corresponding second vial 20. The vials 16, 20 are made from a suitable material, such as borosilicate glass, quartz, or clear plastic, for Raman measurements.

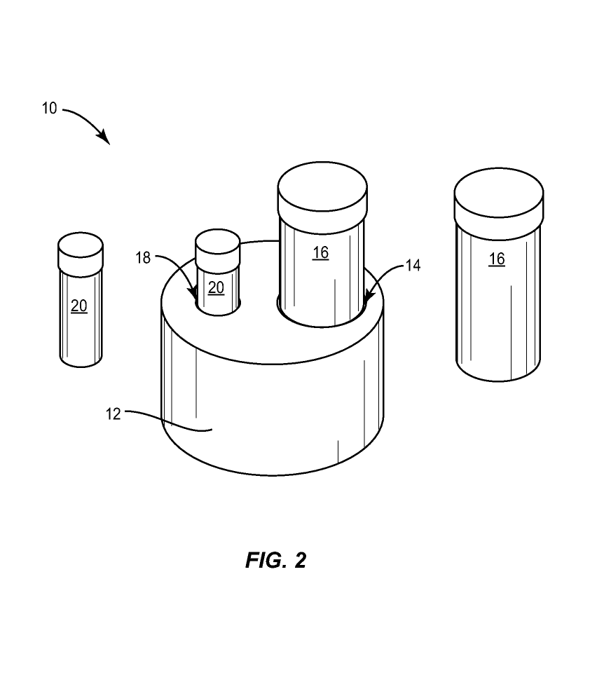

The receptacles 14, 18 and corresponding vials 16, 20 are preferably distinct, such as being of different diameters, as depicted in FIG. 1. Of course, the receptacles 14, 18 could be differentiated in other ways—for example, one hole could be square, triangular, or another shape unique from the other hole, with the vials 16, 20 correspondingly shaped. However, since cylindrical vials 16, 20 are common and available in a variety of sizes, the preferred embodiment features cylindrical receptacles 14, 18, distinguished by size. FIG. 2 is a view of the vials 16, 20 outside of the container 12, as well as within it.

The receptacles 14, 18, and corresponding vials 16, 20 are preferably differentiated to reduce errors in performing calibrated Raman spectroscopy. By establishing a standard protocol—for example, reference material is always placed in the smaller vial 20, and sample material is always placed in the larger vial 16—more consistent results may be expected, and sample and reference materials are handled and stored consistently. However, differentiation of the receptacles 14, 18 is not a critical feature of the present invention, and in other embodiments, holes of the same size and shape may be formed in the multiple-vial, rotating, sample container 12.

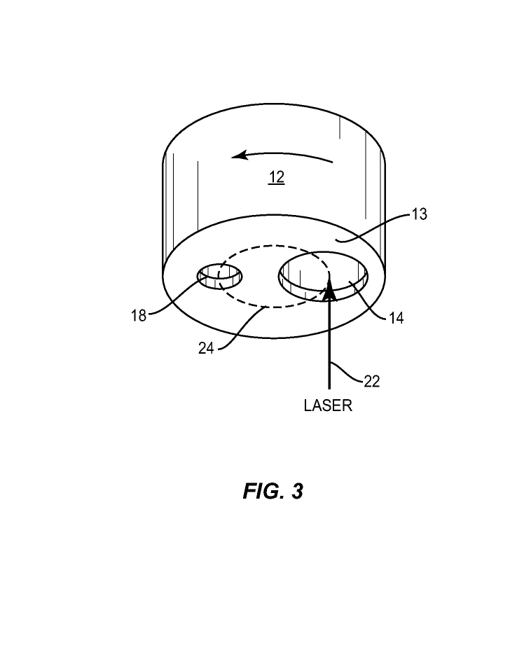

FIG. 3 depicts a bottom view of the multiple-vial, rotating, sample container assembly 10. As the container 12 rotates, a fixed excitation laser beam 22 traces out a circular path 24 on the bottom surface 13 of the container 12. The laser beam incident path 24 passes repeatedly over each hole; Hence, as the container 12 rotates, the excitation laser beam 22 will enter the corresponding vials 16, 20, exciting materials contained therein for Raman spectroscopy. The present invention is not limited to holding two vials 16, 20. In other embodiments (not shown in the figures), the sample container 12 may hold three, four, or more vials, with each being arranged and configured to lie within the path 24 traced by an excitation laser beam 22 as the container 12 rotates during Raman spectroscopy.

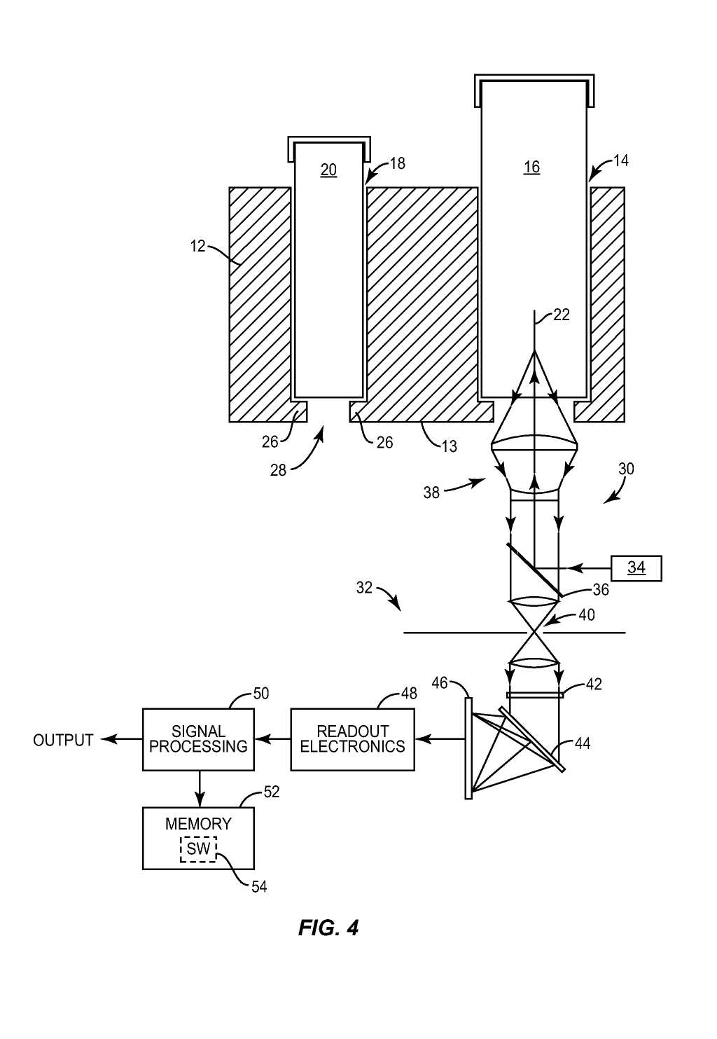

FIG. 4 is a section view of the multiple-vial, rotating, sample container assembly 10, including a representative optical system 30. Each receptacle 14, 18 is formed by a hole extending, at a constant diameter, to nearly, but not completely, the bottom surface 13 of the container 12. At the bottom of the receptacle 18, a through-hole 28, of a smaller diameter, extends through the bottom surface 13 of the container 12, leaving an annular rim 26. The annular rim 26 supports the corresponding vial 20, while the through-hole 28 allows for excitation of material in the vial 20 by laser beam 22, and the collection of Raman scattered photons from the material within the vial 20. Receptacle 14 is constructed similarly; the corresponding parts are not numbered in FIG. 4 for clarity.

FIG. 4 depicts a representative optical system 30 of a Raman spectrometer 32. A laser source 34 generates an excitation laser beam 22. The excitation beam 22 is reflected by a dichroic mirror 36, and directed toward the container 12 so as to trace a circular path 24 when the container 12 rotates (see FIG. 3). The excitation beam 22 passes through an assembly 38 of lenses. The collimated excitation beam 22 has a small diameter compared to the lenses 38. It passes through the center of the lenses 38 where the excitation beam 22 is normal to the lens surfaces and experiences little refraction, thus remaining substantially collimated. Additionally, the excitation beam 22 has a very small “dot” of cross-section area, and the lenses 38 do little to focus or otherwise optically alter the excitation beam 22.

The lens assembly 38 has a fixed focus point configured to lie within a vial 16, 20 when the corresponding hole 28 is positioned over the optical system 30. As one non-limiting example, the lens assembly 38 may comprise a two-element inverse Galilean Telescope lens system, comprising anti-reflection coated quartz elements. At the focal point of the lens assembly 38, Raman scattering may be modeled as a point source optical phenomenon, with isotropic emission. Raman scattered photons are collected from the focal point as an optical signal, the envelope of which is depicted in FIG. 4. This optical signal passes through the dichroic mirror 38, and is focused by lenses to a point, where it passes through a spectrometer aperture slit 40, which isolates the interior of the spectrometer 32 (in particular, the detector 46) from extraneous photons. In one embodiment, a laser rejection dichroic filter 42 blocks photons at the wavelength of the excitation laser beam 22. This removes most non-Raman scattered photons (e.g., Rayleigh scattered photons), which have the same wavelength as the excitation laser beam 22, from the optical signal, thus enhancing the signal to noise ratio (SNR) of the Raman spectroscopy signal.

A transmission grating 44 then directs the collected, Raman scattered photons to a detector 46. In one embodiment, the transmission grating 44 is a holographic transmission grating comprising a transparent window with periodic optical index variations, which diffract different wavelengths of light from a common input path into different angular output paths. In one embodiment, the holographic transmission grating 44 comprises a layer of transmissive material, such as dichromated gelatin, sealed between two protective glass or quartz plates. The phase of incident light is modulated, as it passes through the optically thick gelatin film, by the periodic stripes of harder and softer gelatin. In another embodiment, the transmission grating 44 comprises a “ruled” reflective grating, in which the depth of a surface relief pattern modulates the phase of the incident light. In all embodiments, the spacing of the periodic structure of the transmission grating 44 determines the spectral dispersion, or angular separation of wavelength components, in the diffracted light. In one embodiment, the detector 46 comprises a charge-coupled device (CCD) array. The detector 46 converts incident photonic energy to electrical signals, which are processed by readout electronics 48.

The spectroscopy data from the readout electronics 48 are analyzed by a signal processor 50, such as an appropriately programmed Digital Signal Processor (DSP) or other microprocessor, also operatively connected to memory 52. Data representing the processed Raman spectra may be stored, output to a display, transmitted across a wired or wireless network, or the like, as known in the art. In addition to analyzing Raman spectra data, the signal processor 50—or another processor (not shown in FIG. 4)—may additionally control the overall operation of the spectrometer 32, including initialization, calibration, testing, control of mechanical means for rotating the container 12 (not shown), automated data acquisition procedures, user interface operations, remote communications, and the like. The memory 52 may comprise any non-transient machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, etc.), or the like. The memory 52 is operative to store program instructions 54 operative to implement the functionality described herein, as well as general purpose control functions for analytical instrumentation, as well known in the art.

The Raman spectrometer 32 and its optical system 30 as depicted in FIG. 4 are representative only, and the above description is provided only to enable those of skill in the art to practice embodiments of the present invention. Specific details of the spectrometer 32 and the optical system 30 are not critical features of the present invention. Any optical system 30 capable of directing an excitation laser 22 through the holes 28 of the container 12, and collect Raman scattered photons from within vials 16, 20, and any spectrometer 32 capable of performing Raman spectroscopy, may be advantageously employed in embodiments of the present invention.

Not depicted in FIG. 4 is a mechanism for spinning the multiple-vial, rotating container 12. Rotating mechanisms are well known in the art, and any means of imparting rotary motion to the container 12 may be employed. In one embodiment, the container 12 is sized and shaped so as to be inserted into the rotating sample chamber of a Verifier™ Tri-Test 1000 (VTT-1000) analytical instrumentation system, available from Mustard Tree Instruments of Research Triangle Park, N.C. The multiple-vial, rotating container 12 is preferably rotated at a speed greater than 100 revolutions per minute (RPM).

An additional benefit to rotating the vials 16, 20 into and out of the contact point of the excitation laser beam 22 is that the potential for deleterious thermal effects is minimized, as compared to a prior art Raman spectroscopy technique, where an excitation laser beam is concentrated on a single spot for an extended period of time. Deleterious thermal effects may include degradation of the material, phase change, oxidation/explosion, or the like.

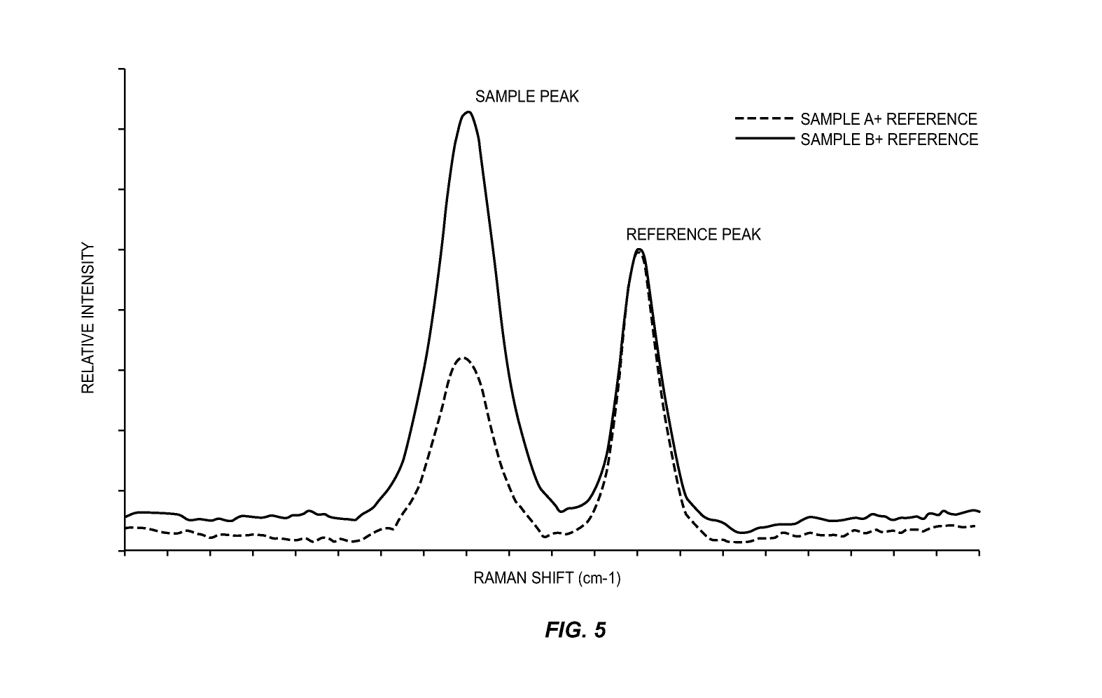

In one embodiment, the multiple-vial, rotating Raman spectroscopy assembly 10 is useful in analytically determining the concentration of analyte in a sample of material. The concentration is determined by the relationship between the size of a Raman peak characteristic of the analyte and a reference peak, the latter caused by a reference material. In a series of Raman spectroscopy runs, the concentration of analyte in a sample in one vial 16 is varied. At each concentration, Raman spectroscopy is performed of the sample and a reference material in the other vial 20. FIG. 5 depicts representative Raman spectra for two such runs (i.e., two different concentrations of analyte in the sample in vial 16.

Raman shifts are typically described as wavenumbers, which have units of inverse length. A wavenumber relates to frequency shift by

$$Δ w = ( \frac{1}{{λ}_{0}} - \frac{1}{{λ}_{1}} )$$

where
w is the wavenumber;
λ₀ is the wavelength of the excitation laser beam 22; and
λ₁ is the wavelength of the Raman scattered photon.

Quantitative analysis of the concentration of analyte is determined by the following equations. First, the intensity of a sample peak is proportional to the concentration of analyte in the sample:

I_{S}∝[C_{S}] (1)

However, the intensity of the reference peak is constant (k)—nothing about the reference material in vial 20 changes between Raman spectroscopy runs:

I_{R}=k (2)

Finally, the ratio of a sample peak to the reference peak indicates the concentration of analyte in a sample:

$$\frac{{I}_{S}}{{I}_{R}} \to [ {C}_{S} ] \qquad ( 3 )$$

where I_{S} is the intensity of a sample peak,
I_{R} is the intensity of the reference peak,
[C_{S}] is the concentration of analyte in the sample, and
k is a constant.

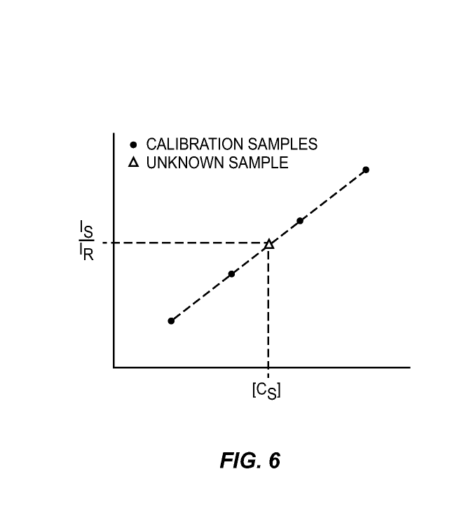

A series of calibration samples, comprising known concentrations of the analyte, may be measured and the ratio of the sample peak to the reference peak may be plotted, yielding the graph of FIG. 6. An unknown sample may then be measured, and the ratio of the two peaks determined from the calibration curve. Using the linear relationship between peak ratios and concentration, the amount of analyte in the unknown sample may be determined.

Embodiments of the present invention present numerous advantages over the prior art. Raman spectra may be captured from both a sample and a reference material at the same time, without mixing the materials. Thus, chemical reactions between them are not a concern. Furthermore, the Raman signal (which is always weak, comprising only approximately 1% of all scattered photons) is not degraded by passing it through a gel filter to collect spectra from a reference material. The spinning container also minimized thermal effects potentially caused by the excitation laser beam.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A Raman spectroscopy system, comprising:
an excitation laser source operative to selectively generate an excitation laser beam in a fixed position;
an optical system operative to collect Raman scattered photons from material excited by the laser beam;
a detector positioned and operative to detect Raman scattered photons collected from the material;
a data processor operative to analyze the spectra of Raman scattered photons detected by the detector; and
a rotating container having at least two receptacles formed therein, each receptacle operative to hold a vial containing material to be analyzed by the Raman spectroscopy system, the receptacles arranged to alternately pass each vial within the optical path of the excitation laser beam as the container rotates.

2. The system of claim 1 wherein the rotating container is positioned over the optical path of the excitation laser beam, and wherein each receptacle has a hole in the bottom thereof allowing the excitation laser beam to pass into a vial disposed therein.

3. The system of claim 1 wherein the at least two receptacles and corresponding vials are differentiated from each other uniquely physically match each vial with its corresponding receptacle.

4. The system of claim 3 wherein the vials and receptacles are substantially cylindrical, and are differentiated by diameter.

5. A method of performing Raman spectroscopy on two or more different materials simultaneously, comprising:
providing an excitation laser source operative to selectively generate an excitation laser beam in a fixed position;
providing at least two materials, each in a vial disposed in a rotating container;
rotating the container such that each vial is alternately illuminated by the excitation laser beam as the container rotates; and
performing Raman spectroscopic analysis on an optical signal generated by the excitation laser alternately illuminating each material as the container rotates.

6. The method of claim 5 wherein one vial contains a reference material having a known Raman spectra different from a sample material contained in a different vial.

7. The method of claim 5 wherein one vial contains a sample comprising a concentration of an analyte in a solvent, and a different vial contains a reference material having a known Raman spectra different from the analyte.

8. The method of claim 5, further comprising:
performing a first Raman spectroscopic analysis wherein the sample comprises a first concentration of the analyte in the solvent;
performing a second Raman spectroscopic analysis wherein the sample comprises a second concentration of the analyte in the solvent;
performing a third Raman spectroscopic analysis wherein the sample comprises an unknown concentration of the analyte in the solvent; and
determining the concentration of analyte in the third analysis in a calibration procedure, in response to the first and second analyses of the analyte and the reference material.

9. The method of claim 8 wherein the calibration procedure comprises:
for each of the first and second analyses, calculating a ratio of the intensity of a characteristic sample peak to the intensity of a characteristic reference peak;
determining a mathematical relationship between the intensity ratios and the concentrations of the analyte in the sample;
calculating a ratio of the intensity of the characteristic sample peak from the third analysis to the intensity of the characteristic reference peak; and
determining the concentration of analyte in the solvent in the third analysis using the mathematical relationship.

10. The method of claim 9 wherein the mathematical relationship is linear.

11. A non-transient computer readable media storing program instructions operative to control a Raman spectroscopy system including an excitation laser source operative to selectively generate an excitation laser beam in a fixed position, and at least two materials, each in a vial disposed in a rotating container, the program instructions operative to cause a controller to:
control mechanical means to rotate the container such that each vial is alternately illuminated by the excitation laser beam as the container rotates; and
performing Raman spectroscopic analysis on an optical signal generated by the excitation laser alternately illuminating each material as the container rotates.

12. The non-transient computer readable media of claim 11 wherein one vial contains a sample comprising a concentration of an analyte in a solvent, and a different vial contains a reference material having a known Raman spectra different from the analyte.

13. The non-transient computer readable media of claim 5, wherein the program instructions are further operative to cause the controller to:
perform a first Raman spectroscopic analysis wherein the sample comprises a first concentration of the analyte in the solvent;
perform a second Raman spectroscopic analysis wherein the sample comprises a second concentration of the analyte in the solvent;
perform a third Raman spectroscopic analysis wherein the sample comprises an unknown concentration of the analyte in the solvent; and
determine the concentration of analyte in the third analysis in a calibration procedure, in response to the first and second analyses of the analyte and the reference material.

14. The non-transient computer readable media of claim 8 wherein the calibration procedure comprises:
for each of the first and second analyses, calculating a ratio of the intensity of a characteristic sample peak to the intensity of a characteristic reference peak;
determining a mathematical relationship between the intensity ratios and the concentrations of the analyte in the sample;
calculating a ratio of the intensity of the characteristic sample peak from the third analysis to the intensity of the characteristic reference peak; and
determining the concentration of analyte in the solvent in the third analysis using the mathematical relationship.

15. The method of claim 9 wherein the mathematical relationship is linear.
